(19) United States
(12) Patent Application Publication
(10) Pub. No.: US 2019/0068941 A1
(43) Pub. Date: Feb. 28, 2019

(54) Method and process for transmitting a live video stream, with a 360-degree view, from the perspective of a participant in an activity

(71) Applicant: David Anthony O'Sullivan, Nashville, TN (US)

(72) Inventor: David Anthony O'Sullivan, Nashville, TN (US)

(21) Appl. No.: 15/731,942

(22) Filed: Aug. 28, 2017

(51) Int. Cl. H04N 13/00

(52) U.S. Cl. CPC H04N 13/0055; H04N 13/0059; H04N 13/0203

(57) ABSTRACT

A method and process is described for transmitting a live video stream, from the perspective of a participant in an activity that is viewable in a 360-degree format by anyone receiving the video stream. The method comprises: taking of live video by multiple cameras situated around the circumference of either a helmet or article of headgear, or multiple cameras situated around the torso; transmitting the video images wirelessly to a receiver; combining, or stitching, the images together at a receiving terminal to form an output which is a live 360-degree video; making the video available for transmission in either recorded or live format to stream online for viewing via a suitably equipped headset.

Method and process for transmitting a live video stream, with a 360-degree view, from the perspective of a participant in an activity.

### FIELD OF THE INVENTION

The invention relates to a method for capturing images from multiple sources (cameras) situated around the head or torso of a participant in an activity, sending said images to a receiving terminal and combining multiple images into a single 360-degree output to a user viewing device, giving the user the perspective of the participant in the activity.

### BACKGROUND OF THE INVENTION

Although the area of 360-degree video is quite recent, the area of Virtual-Reality is more recent. In addition to the electronic gaming industry, which offers participants first-person viewing while playing a game, the world of live, participant-perspective video is relatively recent, some would even say new.

There are multiple variations of participant-perspective video that could be discussed and for the background of this invention, we will use the example of football, played in the United States, where the players will be using both helmets and torso protection. It is important to understand that this is not the only use for this invention. But sporting activities are the best suited to fully and completely illustrate the invention, even though there are multiple potential uses in multiple scenarios for this invention.

Television companies place multiple cameras—up to potentially thirty in some cases—at a football game to provide multiple angles for the viewers. In addition some stadiums have placed 360-degree cameras in seating so the viewer can get the full viewing experience as if they were seated at the event. More recently some 360-degree cameras were placed in seating for the express purpose of allowing some military personnel to view the Super Bowl as if they were seated next to their families.

None of the current viewing choices, standard or virtual, provide the perspective of a player or participant and this is what the invention seeks to provide.

One option currently available is the view from the eyes of the quarterback in a football game as they attempt to throw a pass to a receiver. While this is innovative and exciting for the viewer, it only shows a specific field of vision and only shows a specific direction. The view is restricted to the direction the quarterback is looking. This does not allow the viewer to see any other direction. This invention will provide that.

Using the same example as above, if the same camera option was provided to the receiver in this instance, the viewer would only see what the receiver would be looking at. Obviously the receiver would be looking for the ball coming through the air but may not be able to look at any oncoming defensive players. This invention will provide that.

Using the same example of a football player, in any position on a team, the cameras which can be placed around the torso of a player will add additional excitement for the viewer as the images they will provide will consist mainly of any tackling which may be involved. However in other sports, the torso-based cameras will provide images which may be more useful than the head or helmet-based cameras.

Other sports such as white-water rafting, rock climbing, horse racing or ice hockey for example, all use head protection and could easily avail of this invention. And while the invention is not limited to sporting activities, it can easily provide significant value in multiple areas.

For example on a construction site, this invention can potentially be added to a hard hat worn on the site and would potentially increase worker safety by allowing a full 360-degree view from the perspective of the worker, potentially preventing injuries by being able to see potentially dangerous objects or situations before an incident occurs. This could save money and increase productivity.

A problem with prior systems that provide images from cameras affixed to individuals is that there is no flexibility with the cameras, meaning if the wearer moves their head up or down, for example, the camera would move in unison with the wearer. This invention is designed to minimize this by having floating cameras which can remain fixed on a specific space while there is some motion with the object to which the cameras are attached.

If we take the example of the view available from the quarterback as referenced above, another problem with prior and existing systems is that while there is the option to view from the perspective of the quarterback, there is only a forward-looking view. This invention allows the viewer or end-user to see behind the quarterback or to either side, even if the quarterback is moving forward and possibly in the act of throwing a pass.

There is no other invention or process available in the market today. This invention connects the world of live sports, virtual reality and viewer immersion in a sporting spectacle. As stated before while the example used in this application is the sport of football, this invention has a variety of potential uses and applications; uses and applications which not only succeed in providing a new source of entertainment and a way to further enhance the viewing experience, but can also be used to enhance the safety of the participants. With the availability of 360-degree live images, the manufacturers of both helmets and torso protection equipment will be able to enhance the design of their equipment using data not available currently.

### SUMMARY OF THE INVENTION

It is the object of the invention to provide a view of an event to a viewer from the perspective of the participant in such an event. The view would be as close to “eye-level” as possible and would simulate as closely as possible what a participant would see.

In an embodiment using the example of a football player, the cameras which are in the helmet are connected in two ways. The first connection is to a battery unit to power the cameras and provide sufficient power to transmit the images. The power may come from either a single battery or an individual battery for each camera depending on the design desired. Whether there are multiple or just a single battery unit, it/they will be enclosed within the interior of the helmet in such a way to not impact either player/participant safety or the overall design of the helmet.

The battery unit or units will be of a rechargeable variety and may be charged wirelessly or via a plug-in method depending on the design desired. In the example of a football player, the estimated time-in-use will be sufficiently short so as to ensure adequate charging of the battery unit/units.

The second connection will be between the camera and the receiving terminal. Each camera will be equipped with its own IP address which will connect to the receiving terminal. This connection will be made over a secure wireless network and will be between each camera and the receiving terminal. Each camera will have a dedicated connection.

Each camera will be placed at a specific distance to allow the images to be combined to form a clear, 360-degree view, giving the viewer the same perspective as the participant. The cameras will possess either standard or “fisheye”-type lenses depending on the activity. Depending on the design desired, the lenses will be able to provide a consistent image with a depth that is optimum for viewer satisfaction. The depth will be set accordingly to ensure the perspective of the viewer is as similar as possible to the perspective of the participant. Each camera will be placed within the overall structure of the helmet and will be protected by a clear lens which shall be of sufficiently protective construction so as to be resistant to impact during the course of the activity. The lens texture will not be dissimilar to the texture of a window in an airplane, giving protection while maintaining a clear field of vision to the cameras.

As the event begins, the cameras will be activated automatically and will begin capturing video images. The initial design of the process indicates that individual images will be sent via each dedicated wireless connection to the receiving terminal. When the receiving terminal receives these images, software will be used to combine—or stitch—the images into a single 360-degree view output. A further embodiment of the process may include a single video file being sent from the cameras to the receiving terminal.

Once the received images are combined—or stitched—the output file is complete. The output file will be available for transmission and/or access to/by viewers. The viewers will be able to access the output files via a smartphone or tablet or similar device capable of accepting and transmitting 360-degree video images. Using a compatible headset, the viewer will then be able to view the video images under the conditions of their agreement with the provider of the video images.

In the same example of a football player, an additional set of cameras may be placed around the torso of the player/participant. These cameras will be of the same design and functionality of the helmet-based cameras yet will give the view from the chest/torso of the participant. All features of the torso-based cameras will be the same as the helmet-based cameras and will provide the same video images. The video images will be processed in the same way as the helmet-based images—via the receiving terminal. The output file from the torso-based cameras will also be viewable via a smartphone, tablet or similar device capable of accepting and transmitting 360-degree video images.

The invention will be further illustrated with reference to the attached drawings, which schematically show embodiments according to the invention. It will be understood that the invention is not in any way restricted to these specific embodiments and that these drawings are to illustrate the overall process only.

### BRIEF DESCRIPTION OF THE DRAWINGS

FIG. 1 depicts the flow of live images between a camera, a receiving terminal and an end user in an exemplary embodiment of the invention where the end user device is not a wireless device.

FIG. 2 depicts a front view of the helmet-based camera or cameras.

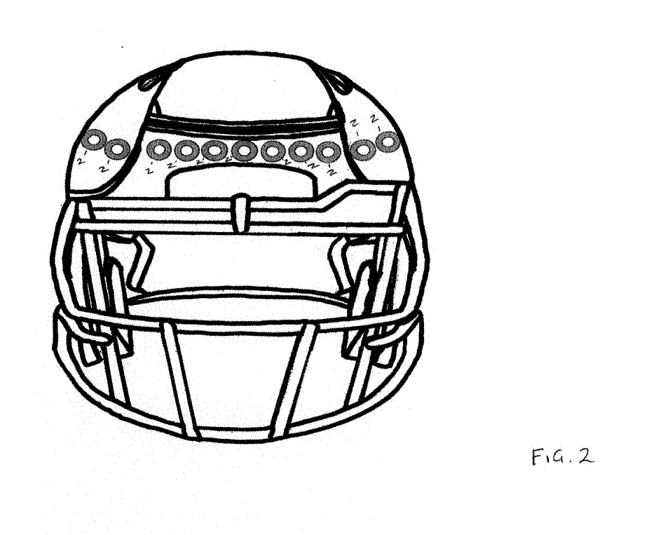

FIG. 3 depicts a side view of the helmet-based camera or cameras.

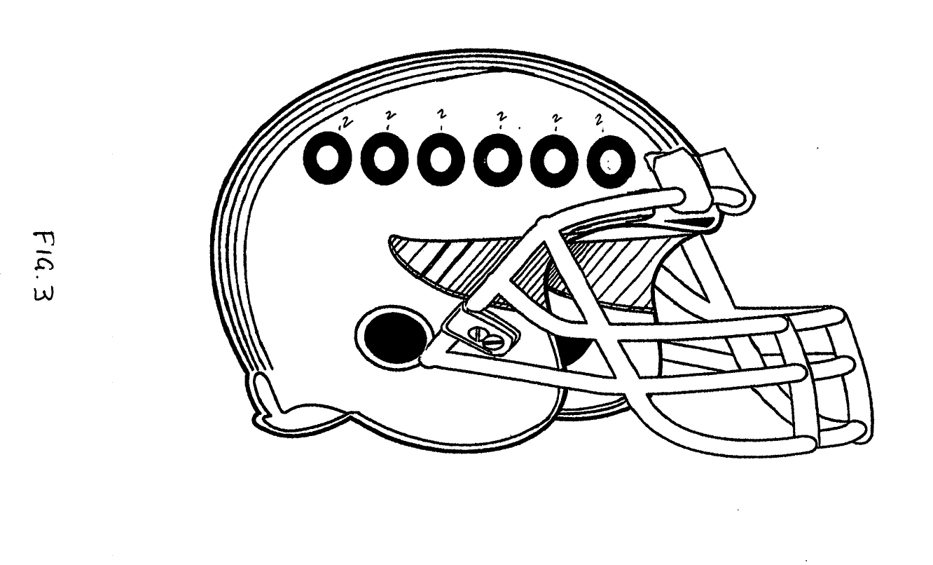

FIG. 4 depicts a front view of the torso-based camera or cameras

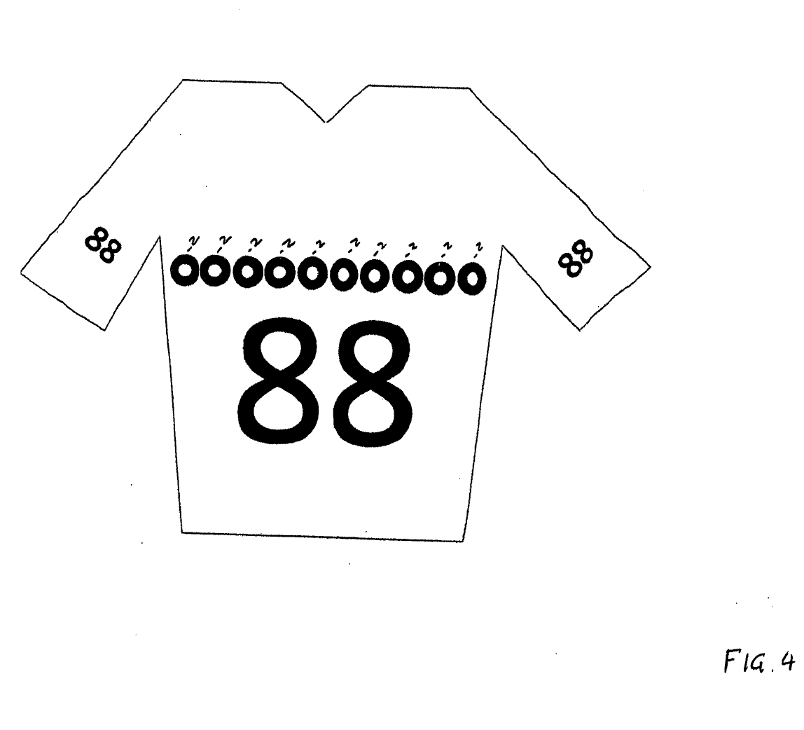

FIG. 5 depicts a front view of the interior wiring of the camera or cameras and associated battery system or systems where the camera or cameras are situated within a helmet.

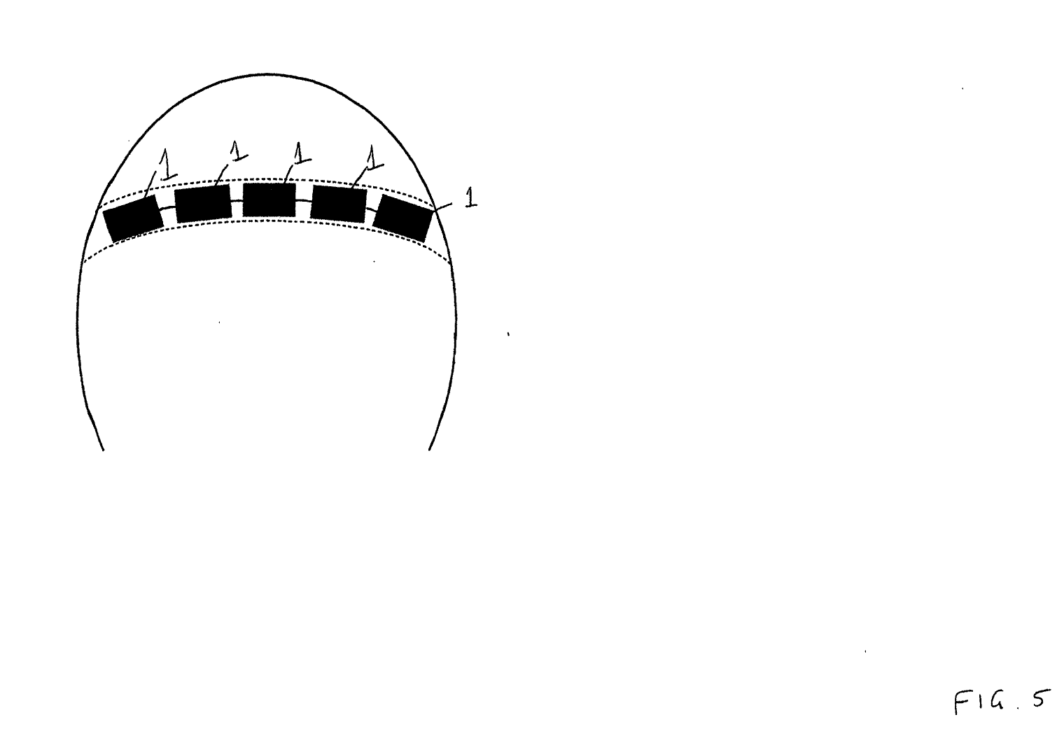

FIG. 6 depicts a view of the connected battery systems as seen from the bottom of the helmet looking towards the crown of the helmet.

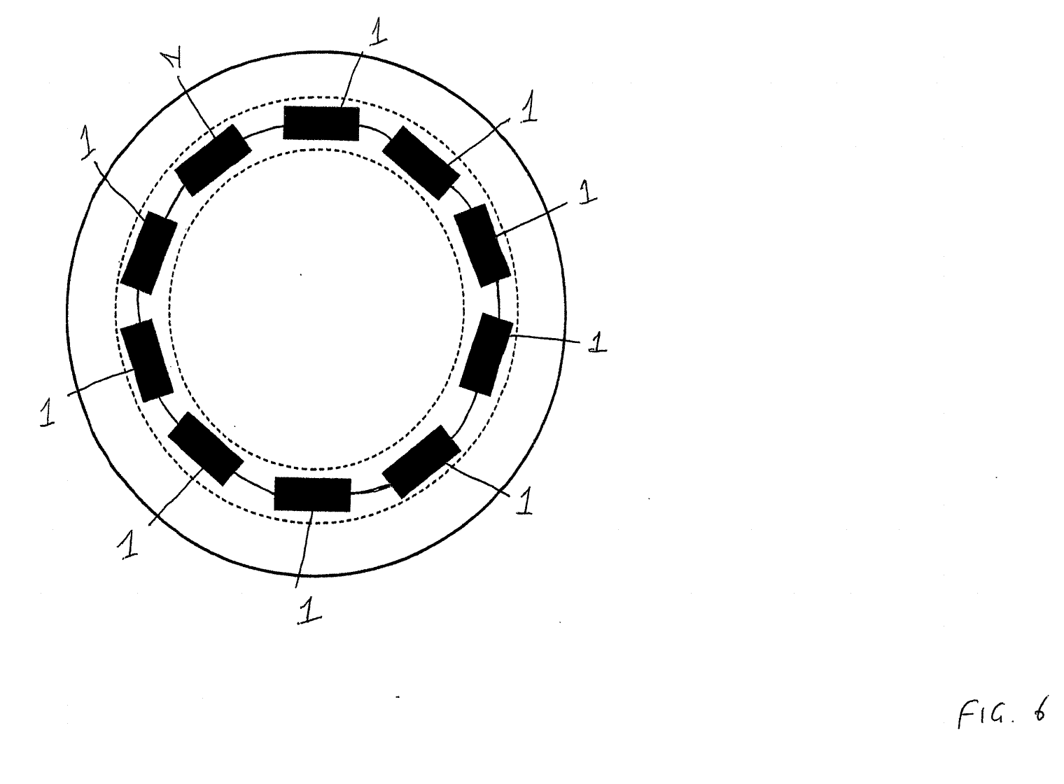

FIG. 7 depicts a view of a single camera and associated battery systems.

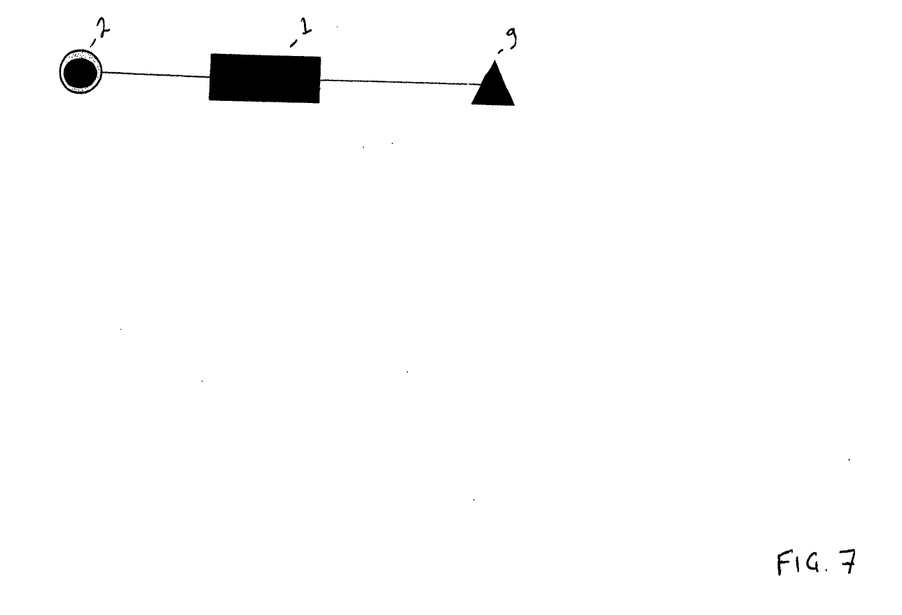

### DETAILED DESCRIPTION

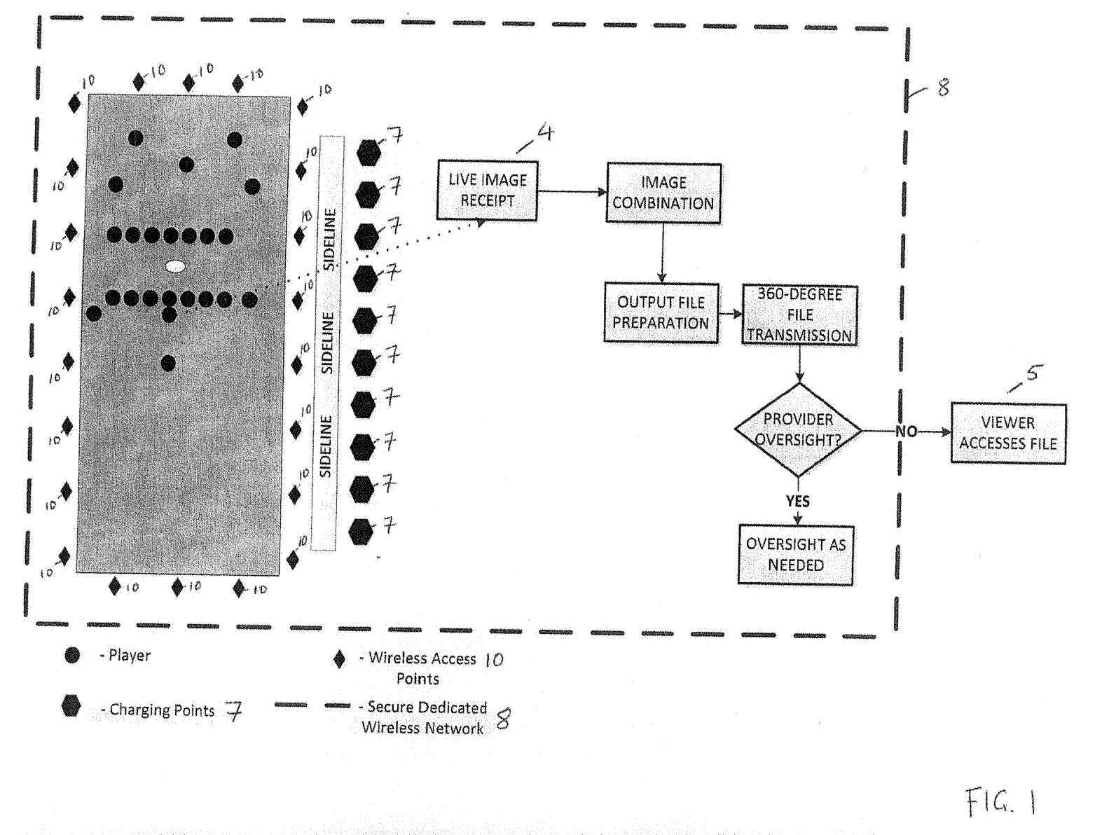

FIG. 1 illustrates an exemplary system in which the present invention may be used. While this invention has many uses and applications, the most practical use and application used for the purposes of this invention is that of the sport of American Football. This sport contains potential uses and applications for the invention using either helmet 3-based or torso-based 6 camera systems 2. In addition, the sport uses helmets 3 which will provide the best possible viewing experience for the end user, given the spherical nature and shape of the helmets 3. Also, the position of the helmets 3 in particular throughout a game of football, will provide the optimum scenario through which this invention can be best exploited. With the majority of players, whether on the offensive or defensive team, running on most occasions in a vertically-aligned position/posture, the live images transmitted by the camera systems 2 will provide a user viewing experience that will be unique, innovative and ground-breaking. This invention is not limited to the sport above, other potential sports where the invention could be used for include ice hockey, motor racing—including open-wheel racing, horse racing, cycling, mountain climbing, polo, motorcycling in addition to other activities. Other activities may include for example, any industrial or construction work which includes the wearing of hard hats or helmets 3 such as highway maintenance or construction for example.

In the example of the sport of football, part of the uniform for each player is a helmet 3 in addition to a variety of protection for the remainder of certain areas of the body, including the torso. This invention includes the placing of a number of cameras 2 around the circumference of the helmet 3. Each camera 2 will have a field of vision which will allow for forward and lateral views of a specific area around the player. Each camera 2 will be attached to a battery system 1 and will accept either a prior single charge or multiple/repetitive top-up charges during the course of an event. Due to the significant impact potential for a helmet 3, this invention places the cameras 2 and battery systems 1 within the interior of the helmet 3 without sacrificing any of the safety features of the helmet 3. The camera 2 lenses will be either standard or “fish-eye” lenses, depending on the greater views provided. Each camera 2 will be attached to a battery system 1 which will either be a single battery system 1 to supply all cameras 2 or an individual battery system 1 per camera 2. On the exterior of the helmet 3, the protection for the camera 2 lens will be a shatterproof, clear material, designed to withstand high pressure impacts and will not be dissimilar to the composition of the windows on an airplane.

The battery system 1 that powers the cameras 2 will either be a single power source and will be located within the helmet 3 in a position which is the least susceptible to impacts. This may be at the back of the helmet 3 but ultimately will be agreed upon with the helmet 3 manufacturer so as to not impact either the use and safety of the helmet 3. The camera 2 and the battery system 1 are connected via a short cable which will be located within the inner structure of the helmet 3.

Prior to the commencement of an event, individual IP addresses will be assigned to each camera 2 on each helmet 3/torso-based 6 system. This will require a block of IP addresses to be set aside by the provider of the secure, wireless network 8. If, for example, there are ten (10) cameras 2 required to provide the complete 360-degree view from each helmet 3 and ten (10) cameras 2 are required to provide the complete 360-degree view from each torso-based 6 cameras 2, and there are 53 players on each team competing, then a total of 2,120 IP addresses will need to be assigned. The IP addresses will be changed for each event and for each location for security purposes. The battery systems 1 on the helmets 3 will be charged prior the event using a standard USB connection to a power source. The battery systems 1 will be linked together using a looped or “daisy-chain” power cord, thus requiring only one standard USB connection for charging. In FIG. 1, along the sideline will be located charging stations 7. These are for topping up the power charge for the helmets 3. The charge from these charging stations 7 will be a high-strength charge, designed to provide power to the battery source at a rate of two-three times a normal power charge. There will also be charging stations 7 within the “home” training facilities of the teams.

The secure, dedicated wireless connection 9s will take advantage of a single, secure wireless network 8 within the arena/stadium where the event is taking place. To ensure there is no gap in the transmission of the images from the helmet 3/torso-based 6 cameras 2 to the receiving terminals, the secure wireless network 8 will use the latest model wireless access points 10 situated along all of the edges of the playing surface. These wireless access points 10 will be situated in close enough proximity to each other to ensure there is no gap in coverage. In addition, these wireless access points 10 will be situated so as not to interfere with any of the playing activities and also to not compromise the safety of the players/participants. To accomplish this, the wireless access points 10 may be positioned at ground level, above ground at a height so as not to interfere with the activities on the field or in another area which does not interfere with the activities. The complete secure wireless network 8 will be independent of any local (stadium/arena) wireless network 8s and will also be encrypted for security purposes. There will be further encryption—where possible—to ensure the only traffic that travels across this secure wireless network 8 will be the images being sent from the cameras 2 on either the helmet 3 or torso of the players/participants.

The images taken by each camera 2 will be transmitted via a secure, dedicated wireless connection 9 to a receiving terminal 4. There will be a secure, dedicated wireless connection 9 between each camera 2 and the receiving terminal 4. This allows for a clear, uninterrupted path for the images to be sent in real time from the camera 2 to the receiving terminal 4. In future technology may be available whereby a single set of images may be sent from the helmet 3 to the receiving terminal 4 but due to the nature of the size of the images and image files, it will be more efficient to use multiple secure, dedicated wireless connections 9 via which to send the images.

This invention calls for the images to be fed from the cameras 2 to the receiving terminals on a constant basis. This would mean there would be images moving between the cameras 2, over the secure, dedicated wireless connections 9, to the receiving terminals constantly while there are players/participants on the playing surface. The security of the secure, dedicated wireless network 8 will be ensured by encryption and also processes related to password management.

Due to the size of the image files and the technical content such as high pixel count, the receiving terminal 4 will need to be sufficiently capable of processing large volumes of image data on a constant basis. There may be a need to engage more than one receiving terminal 4 due to the size of these image files.

The receiving terminals will receive the images from the cameras 2 on the helmet 3, or article of headgear, or torso-based 6 cameras 2. Once received they will need to be combined—or stitched—together to form the 360-degree view. This will be done by software which will combine the images in real time to form the 360-degree view. FIG. 1 depicts the flow of these images.

Should there be a need to engage multiple receiving terminals, an additional combination—or stitching—step will need to be completed. Due to the need for the images to be live, or in real time, this additional step will be completed seamlessly. The additional step will use the same software to combine the images from the additional receiving terminals 4 into a single image for transmission to the viewer 5, or end-user 5.

After the combined images are complete, they will go through an additional oversight step or stage gate prior to presentation to the viewer 5 or end-user 5. This will be mostly inactive thus allowing the images to be transmitted live and in real time. The only time this step will be activated will be if there are commercial reasons for not transmitting images. This could be related to specific advertisers or proprietary content which is not within the agreement between the provider and the viewer 5 or end-user 5.

The viewer 5, or end-user 5, will view the images via a headset that provides 360-degree capability. While the technology may soon exist for stand-alone headsets, this invention will currently work on a headset that typically contains a smartphone. The user will purchase the 360-degree video either as a one-off purchase or within a multi-event agreement with the provider. Once the event is available the user will log in and access the content. This is based upon the push-pull principle, where rather than “push” the 360-degree video to the viewer 5, or end-user 5, the provider will require the viewer 5, or end-user 5 to “pull” the 360-degree video, thus requiring the viewer 5, or end-user 5 to activate the data feed. Although the provider may choose to “push” the data to the market, they may choose to require activation by the viewing population so they can manage the usage of their infrastructure. This allows the provider to engage additional equipment as described above should there be a larger than expected demand for the service.

What is claimed is:

1-42. (canceled)

43. A method of generating 360-degree images comprising:
provisioning one or more cameras affixed to a person capable of capturing one or more images;
sending the one or more images via a dedicated connection to a receiving terminal;
generating, on the receiving terminal, a 360-degree view from the received images;
combining the images into a single 360-degree image; and
providing, by the receiving terminal, one or more combined images to a user.

44. The method of claim 43, wherein the combined images are provided in real time.

45. The method of claim 43, wherein the dedicated connection is a secure wireless network.

46. The method of claim 43, wherein the one or more cameras are activated automatically.

47. The method of claim 43, wherein the one or more cameras are affixed to a helmet.

48. A method of generating 360-degree images comprising:
provisioning one or more cameras affixed to a person capable of capturing one or more images, wherein the one or more cameras communicate over a private wireless local area network;
receiving the one or more images via a dedicated connection to a receiving terminal;
generating, on the receiving terminal, a 360-degree view from the received images;
combining the images into a single 360-degree image; and
providing, by the receiving terminal, one or more combined images to a user.
